(19) United States
(12) Patent Application Publication
(10) Pub. No.: US 2004/0017506 A1
(43) Pub. Date: Jan. 29, 2004

(54) Camera having camera orientation sensing capability

(76) Inventor: Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/206,689

(22) Filed: Jul. 26, 2002

(51) Int. Cl. H04N 5/225; H04N 5/228

(52) U.S. Cl. 348/374; 348/222.1

(57) ABSTRACT

Disclosed are camera orientation sensing systems and cameras that comprise such systems. In one embodiment, a camera includes a camera orientation sensing system configured to determine the orientation of the camera, the sensing system including an orientation sensor that is fixedly positioned relative to the camera body in an angled orientation such that the longitudinal axis of the sensor is not parallel to either of the horizontal or vertical axes of the camera body.

### FIELD OF DISCLOSURE

The present disclosure relates to the field of photography and, more particularly, to determination of camera orientation.

### BACKGROUND

Most cameras are configured to capture images that have an aspect ratio that is not equal to one. In other words, most cameras are configured to capture images that have unequal length and width dimensions. Because of this fact, users often rotate their cameras from a horizontal (“level”) orientation to a vertical orientation to ensure that all desired objects of a viewed scene are captured. For instance, where the camera is configured to generate pictures having a greater dimension in the horizontal direction than the vertical direction, the user may rotate the camera through 90 degrees to capture an image of a relatively tall, narrow object, for example a tall building.

Although such operation of film cameras typically does not create any problems for the user, operation of digital cameras in this manner can be problematic. Specifically, if the user rotates his or her camera to take a picture, for instance from a horizontal to a vertical orientation, the images taken while the camera is in that orientation will be presented in a “sideways” orientation (i.e., rotated 90 degrees) when later viewed with an imaging application running on the user's computer. Although the sideways images can normally be reoriented (i.e., rotated) into a right-side-up orientation using the imaging application, it can be tedious for the user to reorient many different images. In addition, if the user does not save the reoriented version of the images, the user will have to again reorient the images to later view the images in a right-side-up orientation.

Due to the disadvantages that may be realized when digital cameras are used to capture images while the camera is in a rotated orientation, various orientation sensing systems have been developed that are capable of detecting the camera orientation so that the captured image can be automatically reoriented as necessary to present only right-side-up images to the user. In one such system, an orientation sensor comprises a magnetized element acted upon by gravity and stationary Hall-effect transducers. The Hall-effect transducers act as position detectors to determine the relative position of the magnetized element. In another system, an orientation sensor comprises a pivotally supported pendulum switch and a plurality of spaced, immobile contacts.

In yet another orientation sensing system, a gravity responsive disk having different areas of various degrees of light reflectivity is used to determine orientation. A photo-emitter and photo-detector are controlled for emitting and detecting a light source transmitted to and reflected from the disk, respectively. Based on the detected intensity of reflected light, a determination is made as to the orientation of the camera. Other such mechanical arrangements are known (e.g., a weighted light blocking/light passing slotted element positioned between a photo-emitter and photo-detector) that employ light sources (e.g., LEDs).

In view of the fact that mechanical arrangements include mechanical components that are susceptible to wear and failure, other sensing systems that do not rely upon such mechanical components have been developed. In at least one such sensing system, mercury-filled switches are used to determine camera orientation. In such systems, the mercury-filled switches are arranged so as to be parallel with vertical and horizontal axes of the camera. Although such systems avoid some of the problems encountered with cameras that employ mechanical sensing systems, known electrical switch-based sensing systems are susceptible to error in that the switches may incorrectly identify rotation of the camera where the camera is oriented just slightly off from a given axis (horizontal or vertical). For instance, if the user holds the camera such that it is approximately a few degrees (e.g., 5-10 degrees) or more away from perfectly horizontal (“level”), the mercury-filled switches may incorrectly determine that the camera is in the vertical orientation. This can result in an image originally in a correct orientation for viewing being reoriented into a sideways orientation. In addition to being susceptible to orientation sensing error, known electrical switch-based sensing systems include multiple electrical contacts, thereby increasing the complexity, and the cost, of the systems.

In view of the above, it can be appreciated that it would be desirable to have a camera orientation sensing system that avoids one or more of the problems identified in the foregoing.

### SUMMARY

The present disclosure relates to the determination of camera orientation. Accordingly, disclosed are camera orientation sensing systems and cameras that comprise such systems. In one embodiment, a camera including a camera body having a horizontal axis and a vertical axis comprises a camera orientation sensing system configured to determine the orientation of the camera, the sensing system including an orientation sensor that is fixedly positioned relative to the camera body in an angled orientation such that the longitudinal axis of the sensor is not parallel to either of the horizontal or vertical axes of the camera body.

In one embodiment, a camera orientation sensing system comprises an orientation sensor that is fixedly positioned relative to the camera in an angled orientation such that the longitudinal axis of the sensor is not parallel to either of the horizontal or vertical axes of the camera, and logic configured to provide an orientation signal indicating the orientation of the camera relative to a viewed object based upon a determined state of the orientation sensor.

### BRIEF DESCRIPTION OF THE DRAWINGS

FIG. 1 is a is a schematic perspective view of a digital camera that includes a camera orientation sensing system.

FIG. 2 is a block diagram of an example configuration for the camera of FIG. 1.

FIG. 3 is a schematic view that illustrates the states of orientation sensors of the camera of FIGS. 1 and 2 while the camera is in various different orientations.

FIG. 4 is an example look-up table used to correlate orientation sensor state to camera orientation.

FIG. 5 illustrates the reliability of the camera orientation sensing system by identifying that a correct orientation determination is made even when the camera is held in an “off-axis” orientation.

### DETAILED DESCRIPTION

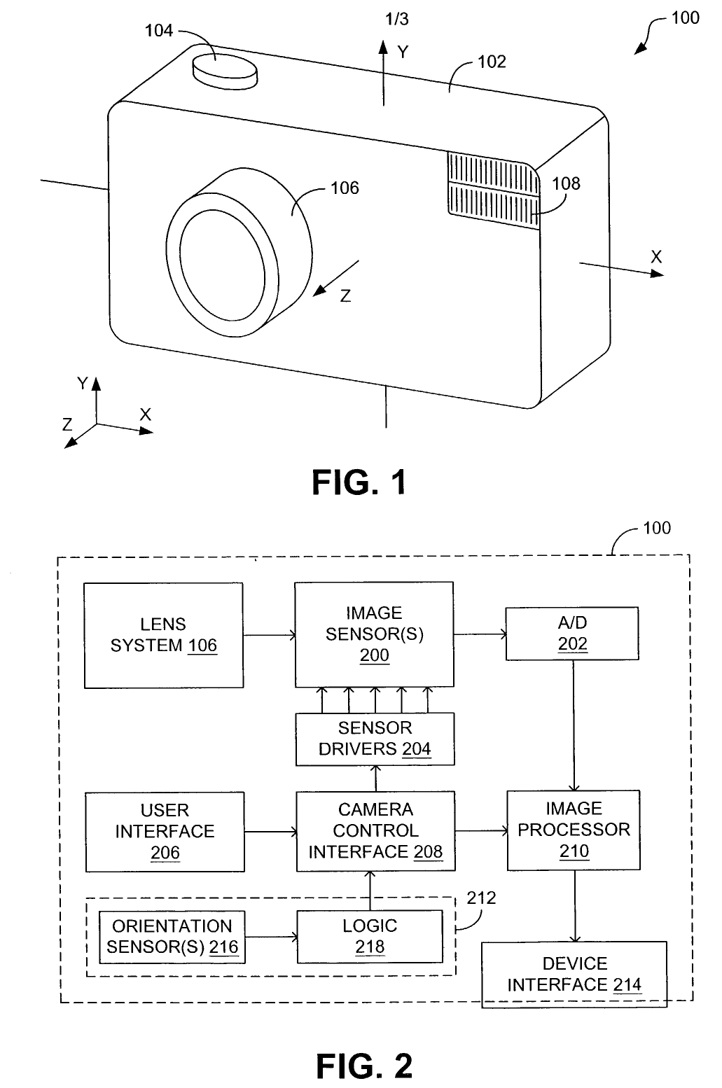

Referring now to the drawings, in which like numerals indicate corresponding parts throughout the several views, FIG. 1 illustrates an example digital camera 100 that incorporates a camera orientation sensing system. Although a particular configuration is shown for the camera 100 in the figure and is described herein, it is to be understood that the camera is merely representative of one example camera embodiment.

As indicated in FIG. 1, the camera 100 can include a camera body 102, a shutter release button 104, a lens system 106, and a flash 108. The camera body 102 can be described as comprising X, Y, and Z axes aligned with the camera body such that the X axis is the horizontal axis of the camera, the Y axis is the vertical axis of the camera, and the Z axis is normal to both the X and Y axes (see FIG. 1). Although particular axes (e.g., “X” and “Y”) are identified relative to the camera body in FIG. 1, their orientations (e.g., directions) have been selected arbitrarily for purposes of describing the camera and its orientation sensing system. Persons having ordinary skill in the art will appreciate that other axis orientations are feasible.

FIG. 2 provides a block diagram of an example architecture for the camera 100 of FIG. 1. As indicated in this figure, the camera 100 includes the lens system 106 identified above and can further include one or more image sensors 200, an analog to digital (A/D) converter 202, sensor drivers 204, a user interface 206, a camera control interface 208, an image processor 210, a camera orientation sensing system 212, and a device interface 214. The lens system 106 comprises one or more lenses that focus images of a viewed objects on the image sensor 200. By way of example, the image sensor 200 comprises a charge-coupled device (CCD). The sensor 200 is clocked by the sensor drivers 204 to produce analog image signals corresponding to still images of the viewed objects. These image signals are converted to digital image signals by the A/D converter 202. The digital image signals are then processed by the image processor 210 and stored in memory, such as a removable solid-state memory card (not shown), which connects to the camera 100 via the device interface 214.

The user interface 206 comprises one or more components available to the user for controlling operation of the camera 100. For instance, the user interface 206 can comprise the shutter-release button 104 identified in relation to FIG. 1.

The camera orientation sensing system 212 is configured to determine whether the camera 100 is in the horizontal (“landscape”) orientation, or in a vertical (“portrait”) orientation. In addition, as is described below, the system 212 is configured to determine whether the camera 100 is being held upside down in an inverted horizontal position. As shown in FIG. 2, the sensing system 212 can include one or more orientation sensors 216 and logic 218 that is configured to provide an orientation signal indicating the orientation of the camera relative to the viewed object to the camera control interface 208.

The image processor 210 is responsive to the orientation signal for processing the image signal and correcting the orientation thereof so that the still image is output from the image processor in a predetermined orientation for viewing and/or storage. Typically, the predetermined orientation is the same for all images, and the image processor 210 converts the vertically oriented images into horizontally oriented images.

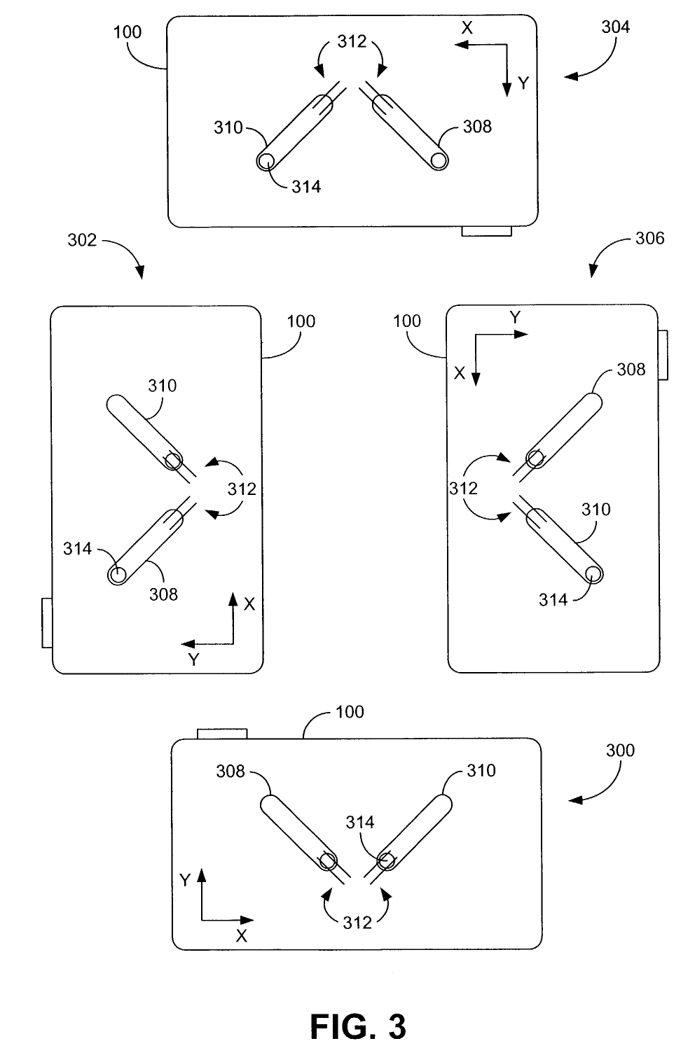

FIG. 3 schematically illustrates example orientation sensors of the camera 100, and the state of these sensors when the camera 100 is placed in various different orientations. In particular, the state of the sensors is shown for situations in which the camera 100 is rotated about its Z axis (FIG. 1) so as to place the camera in one of a landscape orientation 300, a counter-clockwise vertical orientation 302, an inverted landscape orientation 304, and a clockwise vertical orientation 306.

As indicated in FIG. 3, the camera 100 can include first and second orientation sensors 308 and 310. These sensors 308, 310 are fixedly arranged within the camera 100, and therefore typically are not visible to the user. By way of example, each orientation sensor 308, 310 comprises an elongated, gravity-sensitive switch, such as a mercury-filled, single-pole, single-throw (SPST) switch, which includes opposed ends. Although a mercury-filled switch has been explicitly identified herein, it will be appreciated by persons having ordinary skill in the art that other types of gravity-sensitive switches may alternatively be used, if desired.

Each orientation sensor 308, 310 includes a single pair of contacts 312 that is provided in one end of each sensor. For instance, as indicated in FIG. 3, the contacts 312 can be provided in a bottom end of the sensors 308, 310 as the camera 100 is viewed in the landscape orientation 300. In addition, each orientation sensor 308, 310 includes electrically conductive material 314, for instance a droplet of mercury, which can electrically couple the electrical contacts 312 with each other.

As is illustrated in FIG. 3, the longitudinal axes of the orientation sensors 308, 310 are positioned at an angle relative to both the X (horizontal) axis and the Y (vertical) axis of the camera 100. Stated in other words, the sensors 308, 310 are parallel to neither the X or the Y axis of the camera 100. As is explained in greater detail below, this angled arrangement of the orientation sensors 308, 310, permits the orientation of camera 100 to be determined with greater reliably.

As noted above, the orientation sensors 308, 310 are used to positively indicate the orientation of the camera 100 as being one of a landscape orientation 300, a counter-clockwise portrait orientation 302, an inverted landscape orientation 304, or a clockwise portrait orientation 306. These indications are made according to whether there is electrical continuity between the contacts 312 of the sensors 308, 310, i.e. whether the switches of the sensors are open or closed. When the camera 100 is positioned in the landscape orientation 300, the contacts 312 of both orientation sensors 308, 310 are electrically coupled (i.e. the switch is closed). When the camera is positioned in the counter-clockwise portrait orientation 302, the switch of the orientation sensor 308 is open and switch of the orientation sensor 310 is closed. When the camera 100 is positioned in the inverted landscape orientation 304, the switches of both orientation sensors 308, 310 are open. Finally, when the camera 100 is positioned in the clockwise vertical orientation 306, the switch of the orientation sensor 308 is closed and the switch of the orientation sensor 310 is open.

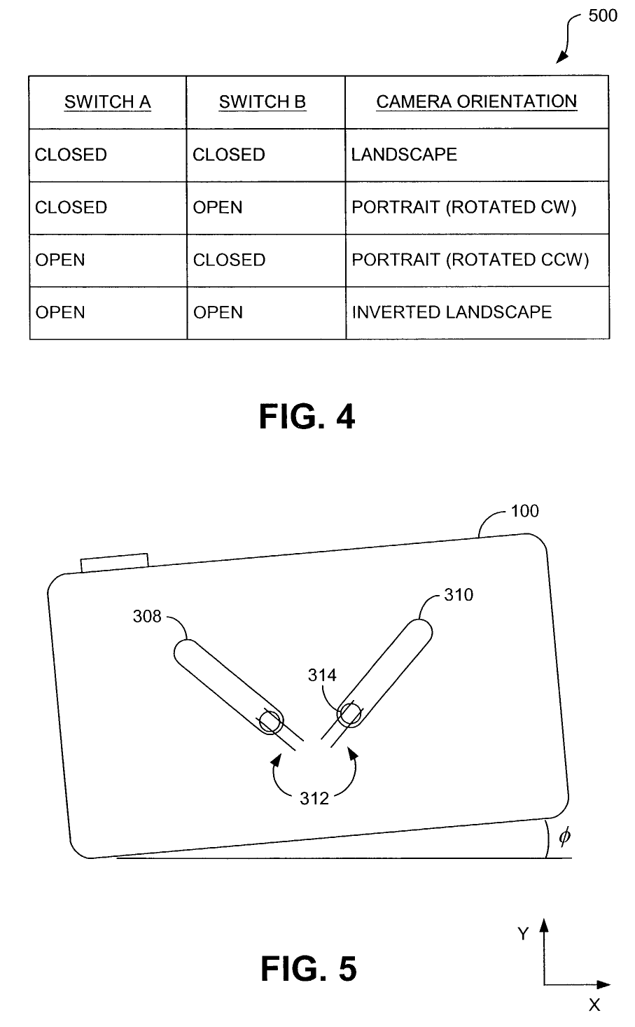

Logic 218 (FIG. 2) determines the state of the sensors 308, 310 and, as described above, provides an orientation signal indicating the orientation of the camera 100 to the camera control interface 208. This orientation signal can expressly identify the orientation, or can be used by the processor 210 to make the orientation determination. In either case, determining the camera orientation may comprise consulting a look-up table, or other reference tool, that correlates the state of the sensors with the camera orientation. An example of one such look-up table is shown in FIG. 4. As is illustrated in this figure, the states of switches A and B, which for instance are the switches provided in sensors 308 and 310, respectively, correspond to the four physical orientations of camera 100 shown in FIG. 3. Thus, the orientation of the camera 100 can be determined in a relatively straight forward manner using only two pieces (e.g., bits) of information.

Once the orientation determination has been made, the camera orientation may be recorded for further processing and/or reported to the camera user. In the former case, the recorded orientation information can be used to ensure that all captured images are presented to the user in a right-side-up orientation. In the latter case, a notification signal indicative of the orientation of camera 100 can be provided to the user during camera use to notify the user as to the camera's current orientation.

As identified above, the angled orientation of the orientation sensors 308, 310 ensures more reliable orientation determinations. This reliability is due to the fact that the sensors 308, 310 are not arranged so as to be parallel with the X (horizontal) and Y (vertical) axes of the camera. Accordingly, false orientation determinations will not occur in situations in which the camera 100 is held slightly off of a particular axis, i.e., rotated about the Z axis such the X and Y axes of the camera no longer align with the horizontal and vertical axes of the viewed object. This phenomenon is illustrated in FIG. 5. As indicated in this figure, even if the camera 100 is rotated so as to form an angle, φ, with the horizontal axis of the object (i.e. the absolute horizontal direction), the droplets 314 still maintain contact with the contacts 312 of each orientation sensor 308, 310. Accordingly, despite the off-axis orientation of the camera 100, the orientation sensing system will still correctly determine that the camera 100 is in the landscape orientation. As can be appreciated by persons having ordinary skill in the art, an erroneous orientation would have likely occurred if one of these sensors had been parallel with the X (horizontal) axis of the camera.

Persons having ordinary skill in the art will appreciate that advantageous results can be obtained when the orientation sensors 308, 310 are configured at substantially angle (other than zero) relative to the X and Y axes of the camera 100. In one preferred arrangement, however, the orientation sensors 308, 310 are arranged at angle of approximately 45° relative to the X axis (as well as the Y axis) of the camera 100. In such an embodiment, the orientation of the camera 100 can be determined with a tolerance of up to about 45°. Accordingly, slight, or even substantial, off-axis variances in the position of the camera will be tolerated without a false orientation determination being made.

In addition to the increased reliability provided by the camera orientation sensing system, the system provides the advantage of being extremely simple in design (each sensor only requiring a single, simple switch), and therefore relatively inexpensive to produce. Indeed, the simplicity of the sensing systems lends itself to manufacture using “off the shelf” components.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A camera including a camera body having a horizontal axis and a vertical axis, the camera comprising:
a camera orientation sensing system configured to determine the orientation of the camera, the sensing system including an orientation sensor that is fixedly positioned relative to the camera body in an angled orientation such that the longitudinal axis of the sensor is not parallel to either of the horizontal or vertical axes of the camera body.

2. The camera of claim 1, wherein the orientation sensor comprises a gravity-sensitive switch.

3. The camera of claim 2, wherein the orientation sensor comprises a single pole, single throw (SPST) switch.

4. The camera of claim 3, wherein the orientation sensor comprises a mercury-filled switch.

5. The camera of claim 1, wherein the longitudinal axis of the orientation sensor forms an angle of approximately 45 degrees with the horizontal axis of the camera body.

6. The camera of claim 1, wherein the camera orientation sensing system comprises two orientation sensors, each orientation sensor being fixedly positioned relative to the camera body in an angled orientation such that the longitudinal axis of each sensor is not parallel to either of the horizontal or vertical axes of the camera body.

7. The camera of claim 1, wherein the camera orientation sensing system further comprises logic configured to provide an orientation signal indicating the orientation of the camera relative to a viewed object.

8. A digital camera, comprising:
a camera body having a horizontal axis and a vertical axis; and
a camera orientation sensing system configured to determine the orientation of the camera body, the sensing system including two gravity-sensitive orientation sensors, each orientation sensor being fixedly positioned relative to the camera body in an angled orientation such that the longitudinal axes of the sensors are not parallel to either of the horizontal or vertical axes of the camera body.

9. The camera of claim 8, wherein the orientation sensors comprise single pole, single throw (SPST) switches.

10. The camera of claim 9, wherein the orientation sensors comprise mercury-filled switches.

11. The camera of claim 8, wherein the longitudinal axes of the orientation sensors form angles of approximately 45 degrees with the horizontal axis of the camera body.

12. The camera of claim 8, wherein the camera orientation sensing system further comprises logic configured to provide an orientation signal indicating the orientation of the camera body relative to a viewed object.

13. A digital camera having a horizontal axis and a vertical axis, the camera comprising:
a lens system;
an image sensor;
an analog to digital converter;
a camera orientation sensing system configured to determine the orientation of the camera, the sensing system including an orientation sensor that is fixedly positioned relative to the camera in an angled orientation such that the longitudinal axis of the sensor is not parallel to either of the horizontal or vertical axes of the camera;
a camera control interface; and
an image processor.

14. The camera of claim 13, wherein the orientation sensor comprises a gravity-sensitive switch.

15. The camera of claim 13, wherein the orientation sensor comprises a single pole, single throw (SPST) switch.

16. The camera of claim 13, wherein the orientation sensor comprises a mercury-filled switch.

17. The camera of claim 13, wherein the longitudinal axis of the orientation sensor forms an angle of approximately 45 degrees with the horizontal axis of the camera.

18. The camera of claim 13, wherein the camera orientation sensing system comprises two orientation sensors, each orientation sensor being fixedly positioned relative to the camera in an angled orientation such that the longitudinal axis of the sensor is not parallel to either of the horizontal or vertical axes of the camera.

19. The camera of claim 13, wherein the camera orientation sensing system further comprises logic configured to provide an orientation signal indicating the orientation of the camera relative to a viewed object.

20. A camera orientation sensing system for use in a digital camera having a horizontal axis and a vertical axis, the sensing system comprising:
an orientation sensor that is fixedly positioned relative to the camera in an angled orientation such that the longitudinal axis of the sensor is not parallel to either of the horizontal or vertical axes of the camera; and
logic configured to provide an orientation signal indicating the orientation of the camera relative to a viewed object based upon a determined state of the orientation sensor.

21. The sensing system of claim 20, wherein the orientation sensor comprises a gravity-sensitive switch.

22. The sensing system of claim 20, wherein the orientation sensor comprises a single pole, single throw (SPST) switch.

23. The sensing system of claim 20, wherein the orientation sensor comprises a mercury-filled switch.

24. The sensing system of claim 20, wherein the longitudinal axis of the orientation sensor forms an angle of approximately 45 degrees with the horizontal axis of the camera.

25. The sensing system of claim 20, wherein the system comprises two orientation sensors, each orientation sensor being fixedly positioned relative to the camera in an angled orientation such that the longitudinal axis of the sensor is not parallel to either of the horizontal or vertical axes of the camera.

26. A method for indicating the orientation of a camera that has a horizontal axis and a vertical axis, the method comprising:
sensing the state of at least one gravity-sensitive switch of the camera, the switch having a longitudinal axis that is not parallel to either of the horizontal axis or the vertical axis of the camera.

27. The method of claim 26, further comprising the step providing an orientation signal indicating the orientation of the camera relative to a viewed object based upon the sensed state of the orientation sensor.

28. The method of claim 26, wherein the step of sensing the state of at least one gravity-sensitive switch comprises sensing the states of two gravity-sensitive switches, each having a longitudinal axis that is not parallel to either of the horizontal or the vertical axis of the camera.
